(19) United States
(12) Patent Application Publication
(10) Pub. No.: US 2007/0262638 A1
(43) Pub. Date: Nov. 15, 2007

(54) Vehicle and control method of vehicle

(76) Inventors: Shinya Kodama, Susono-shi (JP); Mitsuhiro Tabata, Shizuoka-ken (JP); Michihito Shimada, Mishima-shi (JP); Hiroshi Sato, Susono-shi (JP)

Correspondence Address: KENYON & KENYON LLP, 1500 K STREET N.W., SUITE 700, WASHINGTON, DC, 20005, US

(21) Appl. No.: 11/797,283

(22) Filed: May 2, 2007

(30) Foreign Application Priority Data
May 9, 2006 (JP) 2006-130699

(51) Int. Cl. B60T 13/00

(52) U.S. Cl. 303/9.62; 303/186

(57) ABSTRACT

In the reverse braking control of the vehicle, a master cylinder pressure Pmc generated according to the driver's pressing force of a brake pedal is pressurized by pumps and is supplied as a wheel cylinder pressure of rear wheels. The pressurized master cylinder pressure Pmc is reduced by the on-off control of pressure reducing solenoid valves and is supplied as a wheel cylinder pressure of front wheels. This ensures application of the braking force to the front wheels and the rear wheels at a front-rear ratio having a greater rear wheel fraction than the front-rear ratio during the forward braking control. A greater braking force is thus applied to the rear wheels, which are located at the front in the moving direction of the reverse braking control. This ensures generation of a sufficient braking force and effectively prevents the lock of the front wheels.

### BACKGROUND OF THE INVENTION

1. Technical Field

The present invention relates to a vehicle and a control method of the vehicle.

2. Description of the Related Art

One proposed technique for the vehicle reduces the brake fluid pressure in rear wheels at the time of braking to apply a braking force (see, for example, Japanese Patent Laid-Open Gazette No. 2005-145430). The reduced brake fluid pressure in the rear wheels of this proposed vehicle decreases the braking force applied to the rear wheels and accordingly exerts the antilock effect on the rear wheels during braking.

### SUMMARY OF THE INVENTION

This prior art vehicle has the favorable braking operation during a forward drive but may not have a sufficient braking force or poor safety due to the potential lock of front wheels in braking during a reverse drive. The braking during the reverse drive applies a greater load to the rear wheels than the front wheels. The reduction of the brake fluid pressure in the rear wheels interferes with generation of a sufficient braking force. Application of a large braking force to the front wheels undesirably causes the lock of the front wheels.

In the vehicle of the invention and its control method, there is a requirement for generating a sufficient braking force in braking during a backward motion of the vehicle. In the vehicle of the invention and its control method, there is also a requirement for ensuring safety of the vehicle in braking during the backward motion of the vehicle.

In order to satisfy at least part of the above and the other related requirements, the vehicle of the invention and its control method have the configurations discussed below.

The present invention is directed to a vehicle that includes a braking force application structure, a moving direction detection unit and a braking control module. The braking force application structure includes a pressure regulator for regulating pressure of an operating fluid, and applies a braking force to front wheels and rear wheels at a preset front-rear ratio with regard to an operational pressure of the operating fluid in response to a driver's braking demand operation, while applying a braking force to the front wheels and the rear wheels at another front-rear ratio, which is different from the preset front-rear ratio, with regard to the operational pressure and a regulated pressure of the operating fluid by the pressure regulator. The moving direction detection unit detects a moving direction of the vehicle. The braking control module that, during reverse braking where a backward direction is detected as the moving direction of the vehicle by the moving direction detection unit at a timing of the driver's braking demand operation, controls the braking force application structure to actuate the pressure regulator and apply the braking force to the front wheels and the rear wheels at a front-rear ratio having a greater rear wheel fraction than the preset front-rear ratio.

During the reverse braking where the vehicle moves in the backward direction at the timing of the driver's braking demand operation, the vehicle of the invention controls the braking force application structure to actuate the pressure regulator for regulating the pressure of the operating fluid and apply the braking force to the front wheels and the rear wheels at the front-rear ratio having the greater rear wheel fraction than the preset front-rear ratio during the braking in the forward motion of the vehicle. This arrangement applies the greater braking force to the rear wheels, which are located at the front in the moving direction of the reverse braking, thus enabling generation of a sufficient braking force.

In one aspect of the vehicle of the invention, the braking control module controls the braking force application structure during the reverse braking to apply the braking force to the front wheels and the rear wheels at a front-rear ratio based on a reciprocal of the preset front-rear ratio. This arrangement ensures application of the braking force to the vehicle during the reverse braking, as well as during the forward braking. This effectively prevents the lock of the front wheels, which are located at the back in the moving direction of the reverse braking, and ensures the safety of the vehicle. The preset front-rear ratio may be set to increase a front wheel fraction with an increase in braking force applied to the front wheels and the rear wheels.

In another aspect of the vehicle of the invention, the braking control module controls the braking force application structure during the reverse braking to apply the braking force to the front wheels and the rear wheels at a front-rear ratio corresponding to a load distribution applied to the front wheels and the rear wheels. The braking force is thus applied according to the loading during the reverse braking. This ensures generation of a sufficient braking force and effectively prevents the lock of the front wheels.

In still another aspect of the vehicle of the invention, the braking control module controls the braking force application structure during the reverse braking to increase the braking force applied to the rear wheels with pressure regulation by the pressure regulator. In this case, the braking control module may control the braking force application structure during the reverse braking to decrease the braking force applied to the front wheels with pressure regulation by the pressure regulator. The braking force application structure may include a first system that applies a braking force to a right front wheel and a left rear wheel and a second system that applies a braking force to a left front wheel and a right rear wheel, and the pressure regulator may include a first pressure regulator for regulating the pressure of the operating fluid in the first system and a second pressure regulator for regulating the pressure of the operating fluid in the second system.

In still another aspect of the vehicle of the invention, the vehicle further includes a motor that inputs and outputs power from and to the rear wheels, and an accumulator unit that transmits electric power to and from the motor. The braking control module may control the braking force application structure and the motor during the reverse braking to apply the braking force to the front wheels and the rear wheels with regenerative control of the motor. Thus the braking force may be applied to the vehicle with regenerative control of the motor during the reverse braking.

The present invention is also directed to a control method of a vehicle. The vehicle includes a braking force application structure that has a pressure regulator for regulating pressure of an operating fluid. The braking force application structure applies a braking force to front wheels and rear wheels at a preset front-rear ratio with regard to an operational pressure of the operating fluid in response to a driver's braking demand operation, while applying a braking force to the front wheels and the rear wheels at another front-rear ratio, which is different from the preset front-rear ratio, with regard to the operational pressure and a regulated pressure of the operating fluid by the pressure regulator. When the vehicle moves in a backward direction at a timing of the driver's braking demand operation, the control method controls the braking force application structure to actuate the pressure regulator and apply the braking force to the front wheels and the rear wheels at a front-rear ratio having a greater rear wheel fraction than the preset front-rear ratio.

During the reverse braking where the vehicle moves in the backward direction at the timing of the driver's braking demand operation, the control method of a vehicle of the invention controls the braking force application structure to actuate the pressure regulator for regulating the pressure of the operating fluid and apply the braking force to the front wheels and the rear wheels at the front-rear ratio having the greater rear wheel fraction than the preset front-rear ratio during the braking in the forward motion of the vehicle. This arrangement applies the greater braking force to the rear wheels, which are located at the front in the moving direction of the reverse braking, thus enabling generation of a sufficient braking force.

In one aspect of the control method of a vehicle of the invention, the control method controls the braking force application structure during the reverse braking to apply the braking force to the front wheels and the rear wheels at a front-rear ratio based on a reciprocal of the preset front-rear ratio. This arrangement ensures application of the braking force to the vehicle during the reverse braking, as well as during the forward braking. This effectively prevents the lock of the front wheels, which are located at the back in the moving direction of the reverse braking, and ensures the safety of the vehicle.

In another aspect of the control method of a vehicle of the invention, the control method controls the braking force application structure during the reverse braking to apply the braking force to the front wheels and the rear wheels at a front-rear ratio corresponding to a load distribution applied to the front wheels and the rear wheels. The braking force is thus applied according to the loading during the reverse braking. This ensures generation of a sufficient braking force and effectively prevents the lock of the front wheels.

Instill another aspect of the control method of a vehicle of the invention, the control method controls the braking force application structure during the reverse braking to increase the braking force applied to the rear wheels with pressure regulation by the pressure regulator.

### BRIEF DESCRIPTION OF THE DRAWINGS

FIG. 1 schematically illustrates the configuration of a hybrid vehicle in one embodiment of the invention;

FIG. 2 is a schematic diagram showing the structure of a brake actuator in an HBS mounted on the hybrid vehicle of the embodiment;

FIG. 3 is a flowchart showing a reverse braking control routine executed by a brake ECU in the hybrid vehicle of the embodiment;

FIG. 4 shows one example of a front wheel-rear wheel braking force demand setting map adopted for reverse braking control; and

FIG. 5 shows one example of a front wheel-rear wheel braking force distribution map adopted for forward braking control.

### DESCRIPTION OF THE PREFERRED EMBODIMENT

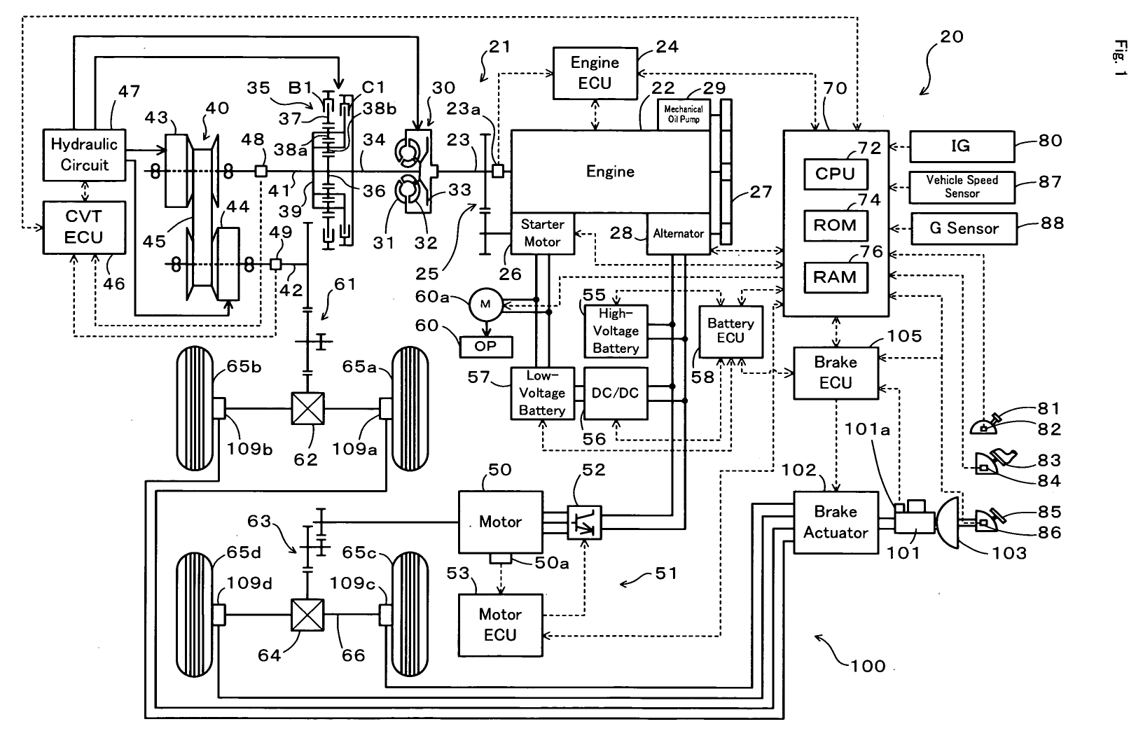

One mode of carrying out the invention is described below as a preferred embodiment with reference to the accompanied drawings. FIG. 1 schematically illustrates the configuration of a hybrid vehicle 20 in one embodiment of the invention. The hybrid vehicle 20 of the embodiment has a front wheel driving system 21, a rear wheel driving system 51, an electronically-controlled hydraulic braking system (hereafter referred to as ‘HBS’) 100 that applies braking force to front wheels 65a and 65b and to rear wheels 65c and 65d, and a hybrid electronic control unit (hereafter referred to as ‘hybrid ECU’) 70 that controls the operations of the whole hybrid vehicle 20. In the front wheel driving system 21, the output power of an engine 22 is transmitted to the front wheels 65a and 65b via a torque converter 30, a forward-reverse switchover mechanism 35, a belt-type continuous variable transmission (hereafter referred to as ‘CVT’) 40, a gear mechanism 61, and a differential gear 62. In the rear wheel driving system 51, the output power of a motor 50 is transmitted to the rear wheels 65c and 65d via a gear mechanism 63, a differential gear 64, and a rear axle 66.

The engine 22 is an internal combustion engine that consumes a hydrocarbon fuel, such as gasoline or light oil, to output power. A crankshaft 23 as an output shaft of the engine 22 is connected to the torque converter 30. The crankshaft 23 is also linked with a starter motor 26 via a gear train 25 and with an alternator 28 and a mechanical oil pump 29 via a belt 27. The engine 22 is under operation control of an engine electronic control unit (hereafter referred to as ‘engine ECU’) 24. The engine ECU 24 inputs signals from various sensors that measure and detect the operating conditions of the engine 22, for example, a crank position signal from a crank position sensor 23a attached to the crankshaft 23, and performs fuel injection control, ignition control, and intake air flow regulation based on the input signals. The engine ECU 24 establishes communication with the hybrid ECU 70. The engine ECU 24 controls the operations of the engine 22 in response to control signals from the hybrid ECU 70, while outputting data regarding the operating conditions of the engine 22 to the hybrid ECU 70 according to the requirements.

The torque converter 30 is a hydraulic torque converter with a lockup clutch and includes a turbine runner 31 linked with the crankshaft 23 of the engine 22, a pump impeller 32 linked with an input shaft 41 of the CVT 40 via the forward-reverse switchover mechanism 35, and a lockup clutch 33. The lockup clutch 33 is actuated by a hydraulic pressure from a hydraulic circuit 47, which is driven and controlled by a CVT electronic control unit (hereafter referred to as ‘CVTECU’) 46 described later, and locks up the turbine runner 31 and the pump impeller 32 of the torque converter 30 according to the requirements.

The forward-reverse switchover mechanism 35 includes a double-pinion planetary gear mechanism, a brake B1, and a clutch C1. The double-pinion planetary gear mechanism includes a sun gear 36 as an external gear, a ring gear 37 as an internal gear arranged concentrically with the sun gear 36, multiple first pinion gear 38a engaging with the sun gear 36, multiple second pinion gears 38b engaging with the respective corresponding first pinion gears 38a and with the ring gear 37, and a carrier 39 coupling the multiple first pinion gears 38a with the multiple second pinion gears 38b to allow both their revolutions and their rotations on their axes. The sun gear 36 and the carrier 39 are respectively connected to an output shaft 34 of the torque converter 30 and to the input shaft 41 of the CVT 40. The ring gear 37 of the planetary gear mechanism is fixed to a casing (not shown) via the brake B1. The engagement and release of the brake B1 stops and allows the rotation of the ring gear 37. The sun gear 36 and the carrier 39 of the planetary gear mechanism are interconnected via the clutch C1. The engagement and release of the clutch C1 connects and disconnects the sun gear 36 with and from the carrier 39. In the forward-reverse switchover mechanism 35 of this structure, the combination of the released brake B1 and the engaged clutch C1 transmits the rotation of the output shaft 34 of the torque converter 30 to the input shaft 41 of the CVT 40 to move the hybrid vehicle 20 forward. The combination of the engaged brake B1 and the released clutch C1 inverts the rotation of the output shaft 34 of the torque converter 30 and transmits the inverted rotation to the input shaft 41 to move the hybrid vehicle 20 backward. The combination of the released brake B1 and the released clutch C1 separates the output shaft 34 of the torque converter 30 from the input shaft 41 of the CVT 40.

The CVT 40 includes a primary pulley 43 that has a variable groove width and is linked to the input shaft 41, a secondary pulley 44 that has a variable groove width and is linked to an output shaft 42 or a driveshaft, and a belt 45 that is set in the grooves of the primary pulley 43 and the secondary pulley 44. The groove widths of the primary pulley 43 and the secondary pulley 44 are varied by the hydraulic pressure from the hydraulic circuit 47, which is driven and controlled by the CVTECU 46. Varying the groove widths of the primary pulley 43 and the secondary pulley 44 in this manner attains the continuously variable speed to convert the input power of the input shaft 41 and output the converted power to the output shaft 42. The groove widths of the primary pulley 43 and the secondary pulley 44 are varied to adjust the clamping pressure of the belt 45 for regulation of a torque transmission capacity of the CVT 40, as well as to regulate the change gear ratio. The hydraulic circuit 47 regulates the hydraulic pressure and the quantity of the hydraulic oil supplied from an electric oil pump 60 driven by a motor 60a and from the mechanical oil pump 29 driven by the engine 22 and supplies the hydraulic oil of the regulated pressure and quantity to the primary pulley 43, the secondary pulley 44, the torque converter 30 (lockup clutch 33), the brake B1, and the clutch C1. The CVTECU 46 inputs a rotation speed Nin of the input shaft 41 from a rotation speed sensor 48 attached to the input shaft 41 and a rotation speed Nout of the output shaft 42 from a rotation speed sensor 49 attached to the output shaft 42. The CVTECU 46 generates and outputs driving signals to the hydraulic circuit 47 based on these inputs. The CVTECU 46 also controls the engagement and the release of the brake B1 and the clutch C1 of the forward-reverse switchover mechanism 35 and performs lockup control of the torque converter 30. The CVTECU 46 communicates with the hybrid ECU 70. The CVTECU 46 regulates the gear change ratio of the CVT 40 in response to control signals from the hybrid ECU 70, while outputting data regarding the operating conditions of the CVT 40, for example, the rotation speed Nin of the input shaft 41 and the rotation speed Nout of the output shaft 42, to the hybrid ECU 70 according to the requirements.

The motor 50 is a synchronous motor generator having the functions of both as a generator and as a motor. The motor 50 is connected via an inverter 52 to an alternator 28 driven by the engine 22 and is linked with a high-voltage battery 55 (for example, a secondary battery having a rated voltage of 42 V) having its output terminal connected to a power line from the alternator 28. The motor 50 is driven with a supply of electric power from the alternator 28 or with a supply of electric power from the high-voltage battery 55, while being under regenerative control to generate electric power and charge the high-voltage battery 55 with the regenerative electric power. The motor 50 is under operation control of a motor electric control unit (hereafter referred to as ‘motor ECU’) 53. The motor ECU 53 inputs various signals required for operating and controlling the motor 50, for example, a signal representing the rotational position of a rotor in the motor 50 from a rotational position detection sensor 50a and a signal representing phase currents applied to the motor 50 from a current sensor (not shown). The motor ECU 53 generates and outputs a switching signal to switching elements of the inverter 52, in response to these input signals. The motor ECU 53 also establishes communication with the hybrid ECU 70. The motor ECU 53 outputs a switching control signal to the inverter 52 in response to a control signal from the hybrid ECU 70 to operate and control the motor 50, while outputting data regarding the operating conditions of the motor 50 to the hybrid ECU 70 according to the requirements. The high-voltage battery 55 is connected with a low-voltage battery 57 via a DC-DC converter 56 that converts the voltage level. The electric power supplied from the high-voltage battery 55 is subject to the voltage conversion and is supplied to the low-voltage battery 57. The low-voltage battery 57 is used as the power source of the electric oil pump 60 and variety of other auxiliary machinery. The high-voltage battery 55 and the low-voltage battery 57 are under control and management of a battery electronic control unit (hereafter referred to as ‘battery ECU’) 58. The battery ECU 58 inputs inter-terminal voltages from voltage sensors (not shown) attached to output terminals (not shown) of the batteries 55 and 57, charge-discharge electric currents from current sensors (not shown), and battery temperatures from temperature sensors (not shown) and computes the states of charge SOC and input and output limits of these batteries 55 and 57 from the input data. The battery ECU 58 communicates with the hybrid ECU 70 and outputs the states of charge SOC and other relevant data to the hybrid ECU 70 according to the requirements.

The HBS 100 mounted on the hybrid vehicle 20 includes a master cylinder 101, a brake actuator 102, and wheel cylinders 109a through 109d provided in the front wheels 65a and 65b and the rear wheels 65c and 65d. The HBS 100 basically works to supply a master cylinder pressure Pmc, which is generated as an operational pressure by the mater cylinder 101 in response to the driver's pressing force of a brake pedal 85, to the wheel cylinders 109a through 109d of the front wheels 65a and 65b and of the rear wheels 65c and 65d via the brake actuator 102 and thus apply the braking force based on the master cylinder pressure Pmc to the front wheels 65a and 65b and to the rear wheels 65c and 65d. In the hybrid vehicle 20 of the embodiment, a brake booster 103 is provided for the master cylinder 101 to assist the driver's braking demand operation. Namely the master cylinder pressure Pmc is given as the total of the driver's pressing force of the brake pedal 85 and the brake booster pressure.

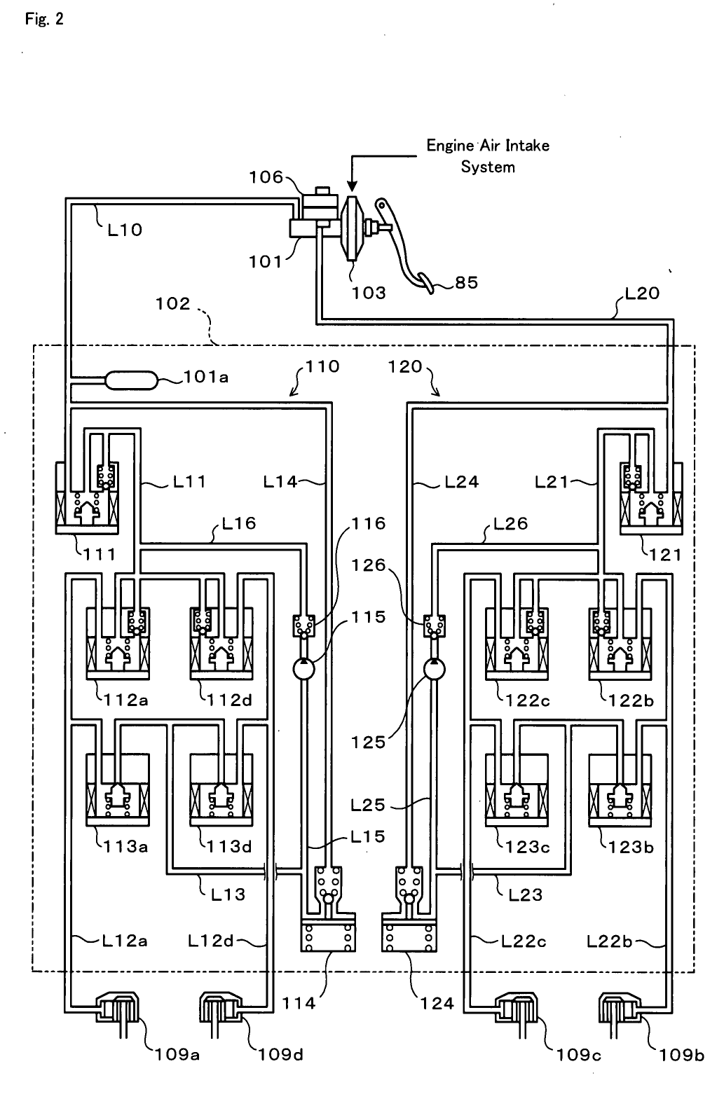

The brake actuator 102 is actuated with the low-voltage battery 57 as the power source to regulate the master cylinder pressure Pmc generated by the master cylinder 101 and supply the regulated master cylinder pressure Pmc to the wheel cylinders 109a through 109d. Irrespective of the driver's depression of the brake pedal 85, the brake actuator 102 regulates the hydraulic pressures in the wheel cylinders 109a through 109d to apply the braking force to the front wheels 65a and 65b and to the rear wheels 65c and 65d. FIG. 2 is the schematic diagram showing the structure of the brake actuator 102. As shown in FIG. 2, the brake actuator 102 is a cross (X)—arranged actuator and has a first system 110 provided for the right front wheel 65a and the left rear wheel 65d and a second system 120 provided for the left front wheel 65b and the right rear wheel 65c. In the hybrid vehicle 20 of the embodiment, the engine 22 for driving the front wheels 65a and 65b is located in its front portion. The front of the hybrid vehicle 20 accordingly has the greater weight distribution. The cross-arranged brake actuator 102 is adopted to ensure application of the braking force to at least one of the front wheels 65a and 65b even in the event of some malfunction of either the first system 110 or the second system 120.

The first system 110 includes a master cylinder cut solenoid valve (hereafter referred to as ‘MC cut solenoid valve’) 111 connected to the master cylinder 101 via an oil supply conduit L10, holder solenoid valves 112a and 112d that are both connected to the MC cut solenoid valve 111 via an oil supply path L11 and are respectively linked with the wheel cylinder 109a for the right front wheel 65a via a pressure-adjusting oil path L12a and with the wheel cylinder 109d for the left rear wheel 65d via a pressure-adjusting oil path L12d. The first system 110 also includes pressure reducing solenoid valves 113a and 113d that are respectively linked with the wheel cylinder 109a for the right front wheel 65a via the pressure-adjusting oil path L12a and with the wheel cylinder 109d for the left rear wheel 65d via the pressure-adjusting oil path L12d, and a reservoir 114 that is connected to both the pressure reducing solenoid valves 113a and 113d via a pressure-reducing oil path L13 and is linked with the oil supply conduit L10 via an oil path L14. A pump 115 included in the first system 110 has an inlet connected to the reservoir 114 via an oil path L15 and an outlet linked with the oil supply path L11 via an oil path L16 having a check valve 116. Similarly the second system 120 includes an MC cut solenoid valve 121 connected to the master cylinder 101 via an oil supply conduit L20, holder solenoid valves 122b and 122c that are both connected to the MC cut solenoid valve 121 via an oil supply path L21 and are respectively linked with the wheel cylinder 109b for the left front wheel 65b via a pressure-adjusting oil path L22b and with the wheel cylinder 109c for the right rear wheel 65c via a pressure-adjusting oil path L22c. The second system 120 also includes pressure reducing solenoid valves 123b and 123c that are respectively linked with the wheel cylinder 109b for the left front wheel 65b via the pressure-adjusting oil path L22b and with the wheel cylinder 109c for the right rear wheel 65c via the pressure-adjusting oil path L22c, and a reservoir 124 that is connected to both the pressure reducing solenoid valves 123b and 123c via a pressure-reducing oil path L23 and is linked with the oil supply conduit L20 via an oil path L24. A pump 125 included in the second system 120 has an inlet connected to the reservoir 124 via an oil path L25 and an outlet linked with the oil supply path L21 via an oil path L26 having a check valve 126.

The MC cut solenoid valve 111, the holder solenoid valves 112a and 112d, the pressure reducing solenoid valves 113a and 113d, the reservoir 114, the pump 115, and the check valve 116 in the first system 110 are respectively identical with the MC cut solenoid valve 121, the holder solenoid valves 122b and 122c, the pressure reducing solenoid valves 123b and 123c, the reservoir 124, the pump 125, and the check valve 126 in the second system 120. Each of the MC cut solenoid valves 111 and 121 is a linear solenoid valve that is full open in the non-power supply state (OFF position) and has its opening adjustable by regulation of the electric current supplied to a solenoid. Each of the holder solenoid valves 112a, 112d, 122b, and 122c is a normally-open solenoid valve that is closed in the power supply state (ON position) and includes a check valve. At the closed position. (ON position) of the holder solenoid valve 112a, 112d, 122b, or 122c, when the hydraulic pressure (wheel cylinder pressure) in the corresponding wheel cylinder 109a through 109d is higher than the hydraulic pressure in the oil supply path L11 or L21, the check valves work to return the flow of brake oil to the oil supply path L11 or L21. Each of the pressure reducing solenoid valves 113a, 113d, 123b, and 123c is a normally-closed solenoid valve that is open in the power supply state (ON position). The pump 115 of the first system 110 and the pump 125 of the second system 120 may be driven by a non-illustrated single driving motor or by individual driving motors (for example, duty-controlled brushless DC motors). The pump 115 or 125 takes in and pressurizes the brake oil from the corresponding reservoir 114 or 124 and supplies the pressurized brake oil to the oil path L16 or L26.

The description regards the operations of the brake actuator 102 constructed as described above. In the base state of the brake actuator 102 shown in FIG. 2, the MC cut solenoid valves 111 and 121, the holder solenoid valves 112a, 112d, 122b, and 122c, and the pressure reducing solenoid valves 113a, 113d, 123b, and 123c are all at the OFF position. In response to the driver's depression of the brake pedal 85, the master cylinder 101 generates the master cylinder pressure Pmc according to the driver's pressing force of the brake pedal 85 and the brake booster pressure. The generated master cylinder pressure Pmc causes the brake oil to flow through the oil supply conduits L10 and L20, the MC cut solenoid valves 111 and 121, the oil supply paths L11 and L21, the holder solenoid valves 112a, 112d, 122b, and 122c, and the pressure-adjusting oil paths L12a, L12d, L22b, and L22c and to be supplied to the wheel cylinders 109a through 109d. The braking force based on the master cylinder pressure Pmc is accordingly applied to the front wheels 65a and 65b and to the rear wheels 65c and 65d. During application of the braking force to the front wheels 65a and 65b and to the rear wheels 65c and 65d, the ON operation (closing operation) of the holder solenoid valves 112a through 122c keeps the hydraulic pressure in the wheel cylinders 109a through 109d. In response to the ON operation (opening operation) of the pressure reducing solenoid valves 113a through 123c, the brake oil in the wheel cylinders 109a through 109d is led through the pressure-adjusting oil paths L12a through L22c, the pressure reducing solenoid valves 113a through 123c, and the pressure-reducing oil paths L13 and L23 to the reservoirs 114 and 124. This reduces the wheel cylinder pressure in the wheel cylinders 109a through 109d. The brake actuator 102 of this embodiment thereby attains the antilock brake system (ABS) control to prevent lock and skid of any of the front wheels 65a and 65b and the rear wheels 65c and 65d by the driver's depression of the brake pedal 85.

Reduction of the openings of the MC cut solenoid valves 111 and 121 and actuation of the pumps 115 and 125 at the timing of the driver's depression of the brake pedal 85 lead the brake oil from a reservoir 106 of the master cylinder 101 to the reservoirs 114 and 124 of the brake actuator 102. The brake oil flowed from the master cylinder 101 to the reservoirs 114 and 124 via the oil paths L16 and L26, the holder solenoid valves 112a through 122c, and the pressure-adjusting oil paths L12a through L22c is pressurized by the pumps 115 and 125 and is supplied to the wheel cylinders 109a through 109d. The operation of the pumps 115 and 125 with adjustment of the openings of the MC cut solenoid valves 111 and 121 attains the brake assist control. The produced braking force is thus based on the sum of the master cylinder pressure Pmc and the additional pressure by the pressurization of the brake oil by the pumps 115 and 125. The individual on-off control of the holder solenoid valves 112a through 122c and the pressure reducing solenoid valves 113a through 123c allows individual and free regulation of the hydraulic pressures in the wheel cylinders 109a through 109d.

The respective elements of the brake actuator 102 including the MC cut solenoid valves 111 and 121, the holder solenoid valves 112a through 122c, the pressure reducing solenoid valves 113a through 123c, and the pumps 115 and 125 are under operation control of a brake electronic control unit (hereafter referred to as brake ECU) 105. The brake ECU 105 inputs the master cylinder pressure Pmc generated by the master cylinder 101 from a master cylinder pressure sensor 101a, a signal from a pressing force detection switch 86, which is mounted on the brake pedal 85 and is mainly used in the event of failure of the brake actuator 102, and wheel speeds from wheel speed sensors (not shown) attached to the front wheels 65a and 65b and the rear wheels 65c and 65d. The brake ECU 105 communicates with the hybrid ECU 70, the motor ECU 53, and the battery ECU 58. The brake ECU 58 operates and controls the brake actuator 102 to perform the brake assist control and the ABS control according to the master cylinder pressure Pmc, the state of charge SOC of the high-voltage battery 55, the rotation speed Nm of the motor 50, and a control signal from the hybrid ECU 70. The brake ECU 58 outputs data regarding the operating conditions of the brake actuator 102 to the hybrid ECU 70, the motor ECU 53, and battery ECU 58 according to the requirements.

The hybrid ECU 70 is constructed as a microprocessor including a CPU 72, a ROM 74 that stores processing programs, a RAM 76 that temporarily stores data, input and output ports (not shown), and a communication port (not shown). The hybrid ECU 70 inputs, via its input port, an ignition signal from an ignition switch 80, a gearshift position SP or a current setting position of a gearshift lever 81 from a gearshift position sensor 82, an accelerator opening Acc or the driver's depression amount of an accelerator pedal 83 from an accelerator pedal position sensor 84, a signal from the pressing force detection switch 86, a vehicle speed V from a vehicle speed sensor 87, and an acceleration a in the forward-backward direction of the hybrid vehicle 20 from a G sensor 88. The hybrid ECU 70 generates various control signals based on these input signals and transmits the generated control signals and data to and from the engine ECU 24, the CVTECU 46, the motor ECU 53, the battery ECU 58, and the brake ECU 105 by communication. The hybrid ECU 70 outputs driving signals to the starter motor 26 and the alternator 28 linked with the crankshaft 23 and control signals to the motor 60a of the electric oil pump 60 via the output port.

The operations of the hybrid vehicle 20 of the embodiment are described below. The description first regards a series of control operations during forward drive of the hybrid vehicle 20 and then regards a series of control operations during reverse drive of the hybrid vehicle 20. When the driver steps on the brake pedal 85 during the forward drive of the vehicle, the master cylinder pressure Pmc generated by the master cylinder 101 according to the driver's pressing force of the brake pedal 85 and the brake booster pressure is supplied as the hydraulic pressure (wheel cylinder pressure) to the wheel cylinders 109a through 109d via the brake actuator 102 in the base state. The braking force based on the master cylinder pressure Pmc is thus applied to the front wheels 65a and 65b and to the rear wheels 65c and 65d. The weight balance during the forward drive of the vehicle is shifted to the front side, compared with the weight balance during the stop of the vehicle. In the base state of the brake actuator 102, the hybrid vehicle 20 of this embodiment has adjusted in advance the front-rear ratio of the frictional braking force by the wheel cylinder pressure in the front wheels 65a and 65b to the frictional braking force by the wheel cylinder pressure in the rear wheels 65c and 65d to have a greater front wheel fraction than the load distribution rate during the stop of the vehicle. For this purpose, the values of dimensions have been regulated and set in advance. Such dimensions include the diameter of the pressure-adjusting oil paths L12a through L22c for the supply of brake oil from the master cylinder 101 to the wheel cylinders 109a through 109d, the rotor outer diameters of frictional brake units for generating the frictional braking force, for example, disk brakes and drum brakes, and frictional coefficients of brake pads. The braking force based on the master cylinder pressure Pmc is applied to the front wheels 65a and 65b and the rear wheels 65c and 65d, such as to give the front-rear ratio having the greater front wheel fraction than the load distribution rate during the stop of the vehicle (for example, the front-rear load ratio of 6 to 4 in the passenger compartment-occupied condition).

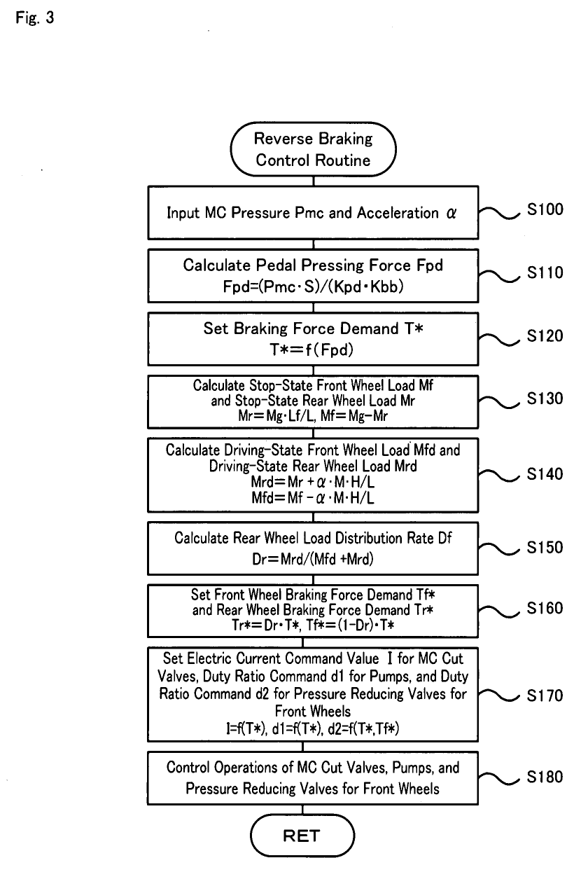

The following describes the series of control operations during the reverse drive of the vehicle. FIG. 3 is a flowchart showing a reverse braking control routine executed by the brake ECU 105. This routine is repeatedly executed at preset time intervals, for example, at every several tens msec, in response to the driver's depression of the brake pedal 85 with the input of a reverse position as the gearshift position SP.

In the reverse braking control routine, a CPU (not shown) of the brake ECU 105 first inputs data required for control, that is, the master cylinder pressure Pmc from the master cylinder pressure sensor 101 and the acceleration α from the G sensor 88 (step S100). The CPU then divides the product of the input master cylinder pressure Pmc and a cylinder area S of the master cylinder 101 by the product of a pedal ratio Kpd of the brake pedal 85 and a servo ratio Kbb of the brake booster 103 to calculate a pedal pressing force Fpd applied to the brake pedal 85 according to Equation (1) given below (step S110):

Fpd=(Pmc·S)/(Kpd·Kbb) (1)

A braking force demand T* required for the hybrid vehicle 20 is then set corresponding to the calculated pedal pressing force Fpd (step S120). The cylinder area S, the pedal ratio Kpd, and the servo ratio Kbb have been stored in advance in a ROM (not shown) of the brake ECU 105. A concrete procedure of setting the braking force demand T* in this embodiment stores in advance a variation in braking force demand T* against the pedal pressing force Fpd in the ROM as a braking force demand setting map and reads the braking force demand T* corresponding to the given pedal pressing force Fpd from this braking force demand setting map. The brake booster 103 may use a negative pressure generated by the engine 22. In this case, a variation in servo ratio Kbb against the negative pressure in the brake booster 103 is stored in advance in the ROM as a servo ratio setting map. The servo ratio kbb is read corresponding to the given negative pressure in the brake booster 103 measured by a pressure sensor (not shown) from the servo ratio setting map.

After setting the braking force demand T*, the CPU calculates a stop-state rear wheel load Mr (=Mg·Lf/L) applied to the rear wheels 65c and 65d in the vehicle stop state and a stop-state front wheel load Mf (Mg−Mr) applied to the front wheels 65a and 65b in the vehicle stop state (step S130). The stop-state rear wheel load Mr is calculated as the product of the vehicle weight ‘Mg’ and the ratio of a horizontal length Lf from the axle of the front wheels 65a and 65b to the center of gravity of the vehicle to a wheel base length L or the length between the front wheel axle and the rear wheel axle. The vehicle weight ‘Mg’ is given as the product of the mass ‘M’ of the vehicle and the gravitational acceleration ‘g’. The stop-state front wheel load Mf is calculated by subtracting the stop-state rear wheel load Mr from the vehicle weight Mg. The mass M of the vehicle, the gravitational acceleration ‘g’, the wheel base length L, and the horizontal length Lf have been stored in advance in the ROM. The mass M of the vehicle may otherwise be obtained from a sensor that detects the vehicle weight Mg as the total weight including the weight of all the passengers and freight.

From the calculated stop-state rear wheel load Mr, the calculated stop-state front wheel load Mf, the input acceleration α, the mass M of the vehicle, and a gravity center height H, the CPU subsequently calculates a driving-state rear wheel load Mrd applied to the rear wheels 65c and 65d in the driving state according to Equation (2) given below and a driving-state front wheel load Mfd applied to the front wheels 65a and 65b in the driving state according to Equation (3) given below (step S140):

Mrd=Mr+α·M·H/L (2)

Mfd=Mf−α·M·H/L (3)

The gravity center height H represents a vertical length from the height of the front wheel axle and the rear wheel axle to the height of the center of gravity of the vehicle. The gravity center height H has been stored in advance in the ROM. In the reverse braking control of the vehicle, the acceleration α has a positive value, and the driving-state rear wheel load Mrd is greater than the stop-state rear wheel load Mr.

A rear wheel load distribution rate Dr=(Mrd/(Mfd+Mrd)) is then calculated by dividing the driving-state rear wheel load Mrd by the sum of the driving-state front wheel load Mfd and the driving-state rear wheel load Mrd (step S150). The CPU multiplies the calculated rear wheel load distribution rate Dr by the braking force demand T* to set a rear wheel braking force demand Tr* required for the rear wheels 65c and 65d and multiplies a front wheel load distribution rate (1−Dr) as a subtraction result of the rear wheel load distribution rate Dr from the value ‘1’ by the braking force demand T* to set a front wheel braking force demand Tf* required for the front wheels 65a and 65b (step S160).

After setting the front wheel braking force demand Tf*, the CPU sets an electric current command value I for varying the openings of the MC cut solenoid valves 111 and 121 and a duty ratio command d1 for the pumps 115 and 125 corresponding to the braking force demand T* required for the vehicle, while setting a duty ratio command d2 for the pressure reducing solenoid valves 113a and 123b of the front wheels 65a and 65b corresponding to the braking force demand T* and the front wheel braking force demand Tf* (step S170). The electric current command value I and the duty ratio command d1 are determined to adjust the openings of the MC cut solenoid valves 111 and 121 and actuate the pumps 115 and 125, so as to ensure application of the braking force demand T* to the front wheels 65a and 65b and the rear wheels 65c and 65d based on the master cylinder pressure Pmc of the brake oil and the additional pressure by the pumps 115 and 125. The duty ratio command d2 is determined to control on and off the pressure reducing solenoid valves 113a and 123b for the front wheels 65a and 65b, so as to reduce the pressure of the brake oil pressurized by the pumps 115 and 125 and ensure application of the front wheel braking force demand Tf* to the front wheels 65a and 65b. A concrete procedure of setting the electric current command value I and the duty ratio command d1 in this embodiment stores in advance a variation in electric current command value I and a variation in duty ratio command d1 against the braking force demand T* as an electric current command value setting map and as a pump duty ratio command setting map in the ROM and reads the electric current command value I and the duty ratio command d1 corresponding to the given braking force demand T* from these maps. A concrete procedure of setting the duty ratio command d2 in this embodiment stores in advance variations in duty ratio command d2 against the braking force demand T* and the front wheel braking force demand Tf* as a pressure reducing valve duty ratio command setting map in the ROM and reads the duty ratio command d2 corresponding to the given braking force demand T* and the given front wheel braking force demand Tf* from the map. The CPU then controls the operations of the solenoids of the MC cut solenoid valves 111 and 121 according to the set electric current command value I, controls the operations of the motors of the pumps 115 and 125 according to the set duty ratio command d1, and controls the operations of the solenoids of the pressure reducing solenoid valves 113a and 123b for the front wheels 65a and 65b according to the set duty ratio command d2 (step S180). After such operation control, the reverse braking control routine is terminated. In the reverse braking control, the master cylinder pressure Pmc generated according to the driver's pressing force of the brake pedal 85 is pressurized by the pumps 115 and 125 and is supplied as the wheel cylinder pressure of the rear wheels 65c and 65d. The pressurized master cylinder pressure Pmc is reduced by the on-off control of the pressure reducing solenoid valves 113a and 123b and is supplied as the wheel cylinder pressure of the front wheels 65a and 65b. The reverse braking control thus enables the greater rear wheel braking force demand Tr* to be applied to the rear wheels 65c and 65d than the braking force applied in the forward braking control, while enabling the smaller front wheel braking force demand Tf* to be applied to the front wheels 65a and 65b than the braking force applied in the forward braking control. The braking force demand T* is adequately distributed to the front wheels 65a and 65b and to the rear wheels 65c and 65d according to the loading. A greater braking force is thus applied to the rear wheels 65c and 65d, which are located at the front in the moving direction of the reverse braking control. This ensures generation of the sufficient braking force and effectively prevents the lock of the front wheels 65a and 65b.

In the hybrid vehicle 20 of the embodiment described above, the reverse braking control operates and controls the MC cut solenoid valves 111 and 121, the pumps 115 and 125, and the pressure reducing solenoid valves 113a and 123b for the front wheels 65a and 65b, in order to ensure application of the braking force to the front wheels 65a and 65b and to the rear wheels 65c and 65d at the front-rear ratio of the greater rear wheel fraction than the front-rear ratio during the forward braking control. The greater braking force is thus applied to the rear wheels 65c and 65d, which are located at the front in the moving direction of the reverse braking control. This ensures generation of the sufficient braking force. The reverse braking control regulates the application of the braking force demand T* to the front wheels 65a and 65b and to the rear wheels 65c and 65d at the rear wheel load distribution rate Dr. This ensures application of the braking force according to the loading and production of the sufficient braking force on the vehicle, while effectively preventing the lock of the front wheels 65a and 65b.

The hybrid vehicle 20 of the embodiment executes the reverse braking control in response to the driver's depression of the brake pedal 85 with the input of the reverse position as the gearshift position SP. The reverse braking control may be executed when the measured vehicle speed V is less than the value ‘0’, for example, when the vehicle goes down on an up hill.

In the base state of the brake actuator 102, the hybrid vehicle 20 of this embodiment has adjusted in advance the braking force applied to the front wheels and to the rear wheels at the front-rear ratio to have a greater front wheel fraction than the load distribution rate during the stop of the vehicle. One possible modification may have adjusted the braking force applied to the front wheels and to the rear wheels at a predetermined front-rear ratio, irrespective of the load distribution rate.

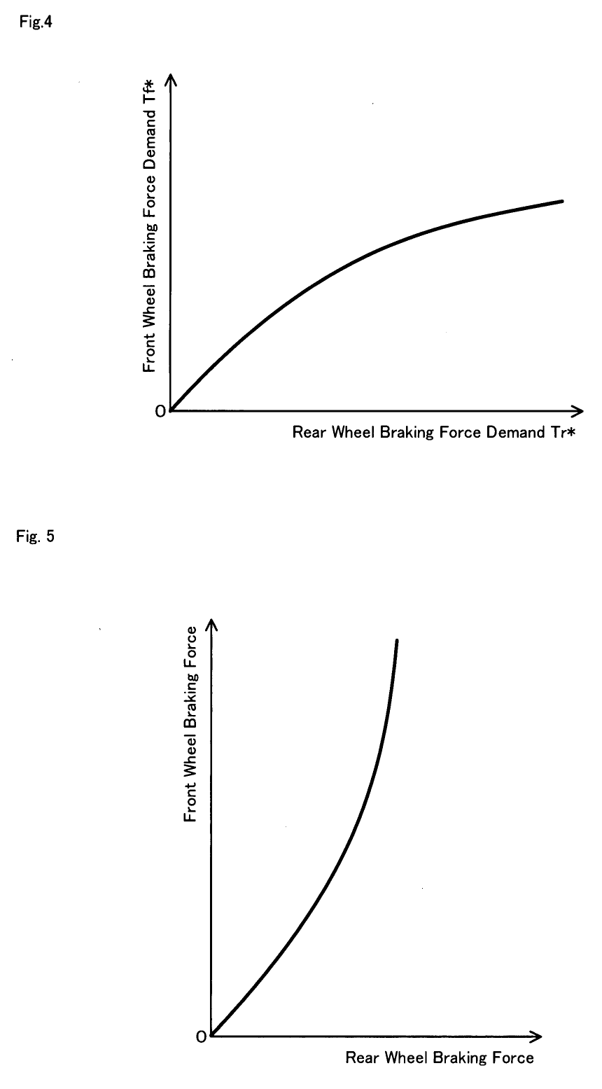

In the hybrid vehicle 20 of the embodiment, the reverse braking control regulates the braking force applied to the front wheels and the rear wheels at the front-rear ratio to have a greater rear wheel fraction than the load distribution rate during the stop of the vehicle. As long as the front-rear ratio of the braking force applied to the front wheels and the rear wheels during the reverse braking control has a greater rear wheel fraction than the front-rear ratio of the braking force during the forward braking control, the reverse braking control may regulate the braking force applied to the front wheels and the rear wheels at the front-rear ratio to have a greater front wheel fraction than the load distribution rate during the stop of the vehicle. In this modification, the brake actuator 102 during the reverse braking control may be controlled to apply the braking force at the front-rear ratio, which is the reciprocal of the front-rear ratio of the braking force applied to the front wheels and the rear wheels during the forward braking control. In the base state of the brake actuator 102, the front-rear ratio may be adjusted to increase the front wheel fraction with an increase in braking force applied to the front wheels and the rear wheels. The braking force at this adjusted front-rear ratio is then applied according to the master cylinder pressure. In this case, the processing flow of steps S130 through S160 is omitted from the reverse braking control routine of the above embodiment. A front wheel-rear wheel braking force demand setting map of FIG. 4 may be used to set the front wheel braking force demand Tf* and the rear wheel braking force demand Tr*. The front wheel-rear wheel braking force demand setting map of FIG. 4 adopted for the reverse braking control is based on the reciprocal of the front-rear ratio in a front wheel-rear wheel braking force distribution map of FIG. 5 adopted for the forward braking control, that is, in the base state of the brake actuator 102. This modified arrangement ensures application of the braking force to the vehicle during the reverse braking control, as well as during the forward braking control. This effectively prevents the lock of the front wheels 65a and 65b, which are located at the back in the moving direction of the reverse braking control, and ensures the safety of the vehicle.

In the hybrid vehicle 20 of the embodiment, the brake actuator 102 has the cross arrangement. The technique of the invention is also applicable to a brake actuator of a front-rear arrangement including a front wheel system for applying the braking force to the front wheels 65a and 65b and a rear wheel system for applying the braking force to the rear wheels 65c and 65d.

In the hybrid vehicle 20 of the embodiment, the brake actuator 102 is controlled to apply the braking force demand T* to the front wheels and the rear wheels during the reverse braking control. One possible modification may control the brake actuator 102 and the motor 50 to ensure application of the braking force demand T* to the front wheels and the rear wheels with regenerative control of the motor 50 for outputting the braking force to the rear wheels 65c and 65d. The hybrid vehicle 20 of the embodiment uses the engine 22 or the internal combustion engine as the power source of the front driving system 21. A motor or another power source may be used for the front driving system 21.

The hybrid vehicle 20 of the embodiment uses the continuously variable transmission CVT 40 as the stepless transmission. The stepless transmission is, however, not restricted to the CVT 40 but may be another type, for example, a toroidal type.

The above embodiment regards the hybrid vehicle 20 as one application of the invention. The technique of the invention is also applicable to any of various vehicles other than the motor vehicles, for example, train vehicles. Another application of the invention is a control method of the vehicle, for example, a motor vehicle or a train vehicle.

The embodiment and its modified examples discussed above are to be considered in all aspects as illustrative and not restrictive. There may be many other modifications, changes, and alterations without departing from the scope or spirit of the main characteristics of the present invention.

The disclosure of Japanese Patent Application No. 2006-130699 filed May 9, 2006 including specification, drawings and claims is incorporated herein by reference in its entirety.

What is claimed is:

1. A vehicle, comprising:
a braking force application structure that has a pressure regulator for regulating pressure of an operating fluid, the braking force application structure applying a braking force to front wheels and rear wheels at a preset front-rear ratio with regard to an operational pressure of the operating fluid in response to a driver's braking demand operation, while applying a braking force to the front wheels and the rear wheels at another front-rear ratio, which is different from the preset front-rear ratio, with regard to the operational pressure and a regulated pressure of the operating fluid by the pressure regulator;
a moving direction detection unit that detects a moving direction of the vehicle; and
a braking control module that, during reverse braking where a backward direction is detected as the moving direction of the vehicle by the moving direction detection unit at a timing of the driver's braking demand operation, controls the braking force application structure to actuate the pressure regulator and apply the braking force to the front wheels and the rear wheels at a front-rear ratio having a greater rear wheel fraction than the preset front-rear ratio.

2. The vehicle in accordance with claim 1, wherein the braking control module controls the braking force application structure during the reverse braking to apply the braking force to the front wheels and the rear wheels at a front-rear ratio based on a reciprocal of the preset front-rear ratio.

3. The vehicle in accordance with claim 2, wherein the preset front-rear ratio is set to increase a front wheel fraction with an increase in braking force applied to the front wheels and the rear wheels.

4. The vehicle in accordance with claim 1, wherein the braking control module controls the braking force application structure during the reverse braking to apply the braking force to the front wheels and the rear wheels at a front-rear ratio corresponding to a load distribution applied to the front wheels and the rear wheels.

5. The vehicle in accordance with claim 1, wherein the braking control module controls the braking force application structure during the reverse braking to increase the braking force applied to the rear wheels with pressure regulation by the pressure regulator.

6. The vehicle in accordance with claim 5, wherein the braking control module controls the braking force application structure during the reverse braking to decrease the braking force applied to the front wheels with pressure regulation by the pressure regulator.

7. The vehicle in accordance with claim 1, wherein the braking force application structure includes a first system that applies a braking force to a right front wheel and a left rear wheel and a second system that applies a braking force to a left front wheel and a right rear wheel, and the pressure regulator includes a first pressure regulator for regulating the pressure of the operating fluid in the first system and a second pressure regulator for regulating the pressure of the operating fluid in the second system.

8. The vehicle in accordance with claim 1, the vehicle further comprising:
a motor that inputs and outputs power from and to the rear wheels; and
an accumulator unit that transmits electric power to and from the motor,
wherein the braking control module controls the braking force application structure and the motor during the reverse braking to apply the braking force to the front wheels and the rear wheels with regenerative control of the motor.

9. A control method of a vehicle, the vehicle having a braking force application structure that has a pressure regulator for regulating pressure of an operating fluid, the braking force application structure applying a braking force to front wheels and rear wheels at a preset front-rear ratio with regard to an operational pressure of the operating fluid in response to a driver's braking demand operation, while applying a braking force to the front wheels and the rear wheels at another front-rear ratio, which is different from the preset front-rear ratio, with regard to the operational pressure and a regulated pressure of the operating fluid by the pressure regulator,
when the vehicle moves in a backward direction at a timing of the driver's braking demand operation, the control method controls the braking force application structure to actuate the pressure regulator and apply the braking force to the front wheels and the rear wheels at a front-rear ratio having a greater rear wheel fraction than the preset front-rear ratio.

10. A control method of a vehicle in accordance with claim 9, said control method controlling the braking force application structure during the reverse braking to apply the braking force to the front wheels and the rear wheels at a front-rear ratio based on a reciprocal of the preset front-rear ratio.

11. A control method of a vehicle in accordance with claim 9, said control method controlling the braking force application structure during the reverse braking to apply the braking force to the front wheels and the rear wheels at a front-rear ratio corresponding to a load distribution applied to the front wheels and the rear wheels.

12. A control method of a vehicle in accordance with claim 9, said control method controlling the braking force application structure during the reverse braking to increase the braking force applied to the rear wheels with pressure regulation by the pressure regulator.
